(19) United States
(12) Patent Application Publication
(10) Pub. No.: US 2026/0277817 A1
(43) Pub. Date: Sep. 17, 2026

(54) KV CACHE-BACKED USER-SELECTABLE CONTINUATION BRANCHES FOR ARTIFICIAL INTELLIGENCE (AI) INFERENCE

(71) Applicant: Dorian Cartwright, San Jose, CA (US)

(72) Inventor: Dorian Cartwright, San Jose, CA (US)

(21) Appl. No.: 19/667,591

(22) Filed: May 4, 2026

(51) Int. Cl. G06F 12/0875

(52) U.S. Cl. CPC G06F 12/0875

(57) ABSTRACT

An artificial intelligence inference system optimizes memory allocation during interactive continuation branching. The system receives an initial query and executes an attention-based model to generate a primary response and a base KV cache state. Alternative continuation branches are generated, branch-specific KV cache states are computed, and the base and branch-specific states are retained in hardware memory using distinct memory pointers in a KV cache page table. The primary response is presented with selectable prompts or voice-response options corresponding to the branches. Upon receiving a selection signal, the system resolves the pointer for the selected branch and resumes generation using the corresponding branch-specific KV cache state, avoiding recomputation for the initial query and selected divergent sequence. Resource-aware prefetch policies may conditionally precompute branch states based on load, memory pressure, predicted selection likelihood, or expected prefetch value.

### FIELD OF THE INVENTION

The present disclosure relates generally to computers and artificial intelligence (AI), and more specifically, to key-value (KV) cache-backed selectable continuation branches in artificial intelligence inference.

### BACKGROUND

Attention-based neural network models, including transformer-based large language models, commonly maintain KV cache data during autoregressive inference. A KV cache stores internal attention state generated from previously processed tokens so that the model does not need to recompute attention-related values for the same prior token sequence each time a new output token is generated.

In conventional conversational artificial intelligence systems, a model may generate a response to a user query and may subsequently display or suggest one or more possible follow-up prompts. Such suggested prompts are typically treated as text labels or user-interface suggestions. If a user selects one of the suggested prompts, the inference system generally processes the selected prompt as a new input or as a continuation from a previously stored conversation history, requiring additional computation to regenerate relevant internal model state associated with the selected continuation.

Some inference-serving systems use virtualized KV cache allocation, paging, or block-based memory management to improve memory utilization during model serving. However, conventional systems do not adequately integrate user-selectable continuation prompts with branch-specific KV cache states that have been precomputed, retained in hardware memory, and mapped to corresponding selectable prompts for immediate continuation after user selection.

Furthermore, precomputing multiple possible continuation branches may improve latency when a user selects one of the branches, but such speculative computation can waste compute, memory bandwidth, power, and high-bandwidth memory when the system is busy or when a branch is unlikely to be selected. Existing systems do not adequately determine when to precompute branch-specific continuation states based on runtime resource conditions, predicted user-selection likelihood, or expected prefetch value.

Accordingly, there exists a need for robust techniques for KV cache-backed selectable continuation branches in artificial intelligence inference.

### SUMMARY

The present disclosure addresses these shortcomings with systems, methods, and computer program products for KV cache-backed selectable continuation branches in artificial intelligence inference.

In one embodiment, an artificial intelligence inference system receives an initial query and executes a forward pass of an attention-based neural network model to generate a primary response. Execution of the forward pass computes a base KV cache state stored in hardware memory. The system generates multiple alternative continuation branches extending from the primary response, each corresponding to a divergent token sequence. The system computes a branch-specific KV cache state for each alternative continuation branch and retains the base KV cache state and the branch-specific KV cache states in hardware memory by registering distinct memory pointers in a KV cache page table.

The system transmits the primary response to a display interface together with selectable user prompts generated from corresponding alternative continuation branches. Upon receiving a selection signal identifying a target prompt, the system resolves a distinct memory pointer in the KV cache page table corresponding to the branch-specific KV cache state of the selected prompt. The system resumes generation of a subsequent response by fetching the corresponding branch-specific KV cache state into a computational core, thereby avoiding recomputation of attention-state computations for the initial query and the divergent token sequence associated with the selected prompt.

In another embodiment, the system supports voice-driven continuation branching. An audio interface outputs a primary response together with audible selectable response options. A voice-to-branch identifier table maps each audible selectable response option to a branch identifier associated with a corresponding branch-specific KV cache state. Upon receiving a spoken selection signal, the system resolves the corresponding branch identifier and retrieves the corresponding branch-specific KV cache state for continued voice-response generation.

In another embodiment, the system includes a resource-aware prefetch policy that determines whether, when, and to what extent branch-specific KV cache states should be precomputed. The prefetch policy may enable branch precomputation when compute is inexpensive or available, such as when accelerator utilization, request queue depth, memory pressure, power usage, thermal constraints, or latency conditions satisfy one or more thresholds. Conversely, the system may suppress, reduce, delay, truncate, compress, demote, or disable branch precomputation when the system is busy or resource constrained.

In another embodiment, the system determines a prefetch value for each candidate continuation branch. The prefetch value may be based on predicted user-selection probability, expected latency savings, compute cost, memory cost, power cost, expiration time, user priority, or service-level objective. Branches having higher prefetch values may be precomputed and retained, while lower-value branches may remain as selectable prompts without retained branch-specific cache state until selection occurs.

In another embodiment, the system predicts a likelihood that a user will select each selectable prompt or voice-response option. The system may rank branches based on predicted selection likelihood and precompute branch-specific KV cache states for a highest-ranked subset. The prediction may be updated based on user behavior, such as cursor hover, dwell time, gaze direction, partial spoken input, semantic similarity between spoken input and a selectable prompt, or interaction history.

Advantageously, the disclosed system improves operation of artificial intelligence inference systems by reducing repeated attention-state computation, reducing response latency after selection of a continuation branch, improving memory allocation for branch-specific inference states, and using available compute capacity to precompute likely future continuations while limiting speculative work during high-load conditions.

### BRIEF DESCRIPTION OF THE DRAWINGS

The present disclosure will be understood more fully from the detailed description given below and from the accompanying drawings of various embodiments of the disclosure.

FIG. 1 is a perspective diagram illustrating a user interface presenting a primary artificial intelligence response together with a plurality of selectable continuation prompts corresponding to alternative continuation branches, according to an embodiment.

FIG. 2 is a schematic diagram illustrating an example KV cache page table that maps a base KV cache state and a plurality of branch-specific KV cache states to displayed branches, according to an embodiment.

FIG. 3 is a schematic block diagram illustrating a prefetch branch module managing KV cache prefetch, according to an embodiment.

FIG. 4 is block diagram illustrating a computing environment, according to an embodiment.

FIG. 5 is a flow chart illustrating a method for cache-backed selectable continuation branching, according to an embodiment.

FIG. 6 is a flow chart illustrating a method for resource-aware prefetching of branch-specific continuation states, according to an embodiment.

FIG. 7 is a flow chart illustrating a method for determining prefetch value and predicted selection likelihood for candidate continuation branches, according to an embodiment.

### DETAILED DESCRIPTION

Systems, methods, and computer program products for KV cache-backed selectable continuation branches in artificial intelligence inference are described. The embodiments described herein are provided by way of example and not limitation. A person of ordinary skill in the art will recognize that numerous modifications, substitutions, and variations may be made without departing from the spirit and scope of the invention.

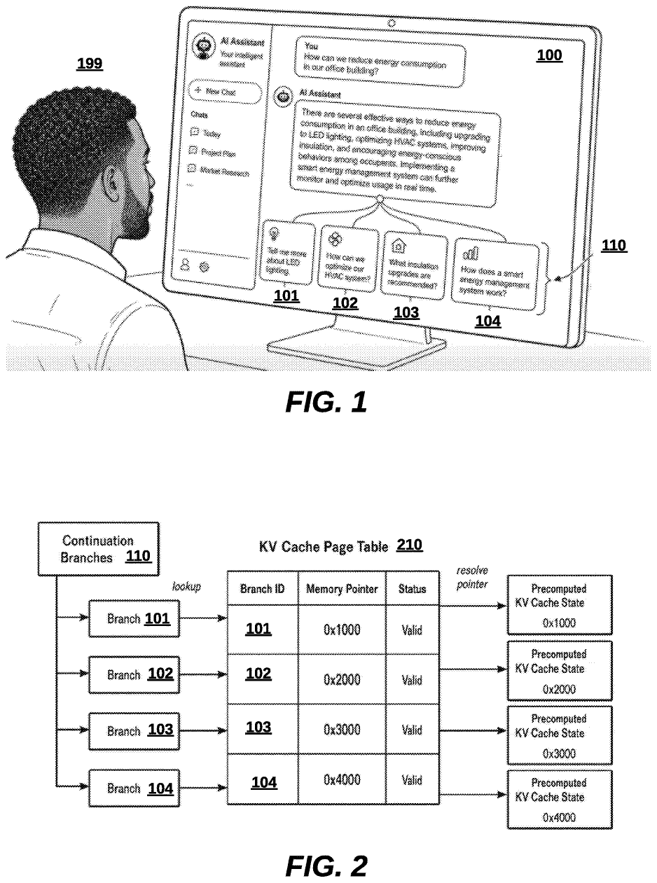

### I. Systems for KV Cache Continuation Branches (FIGS. 1-4)

Referring to FIG. 1, a chatbot system 100 for KV cache-backed selectable continuation branches is illustrated. A user 199 interacts with the chatbot system 100 through a user interface that presents a collection of continuation branches 110 suggested to the user 199 as further inference options based on a current response. Other factors for generating the suggested continuation branches may include previous prompts, previous responses in a current conversation, previous responses in other conversations within a platform, system prompts, or project-specific prompts. The user 199 may select from a plurality of branches 101, 102, 103, and 104 to continue a conversation along a selected branch. Many other variations are possible. For example, the user 199 may communicate by voice with a non-display AI device, such as a humanoid robot, vehicle assistant, smart speaker, or other physical AI device. An inference model behind the chatbot may comprise an attention-based neural network model, transformer-based large language model, multimodal model, speech model, code model, reasoning model, or other model configured to generate output tokens from input tokens.

Turning to FIG. 2, a KV cache page table 210 stores mappings between branch identifiers, prompt identifiers, voice-response option identifiers, memory pointers, page descriptors, cache-block identifiers, base-state identifiers, branch-specific state identifiers, or other addressing metadata. The KV cache page table 210 enables the system to locate a base KV cache state and one or more branch-specific KV cache states without recomputing model state from the original input sequence.

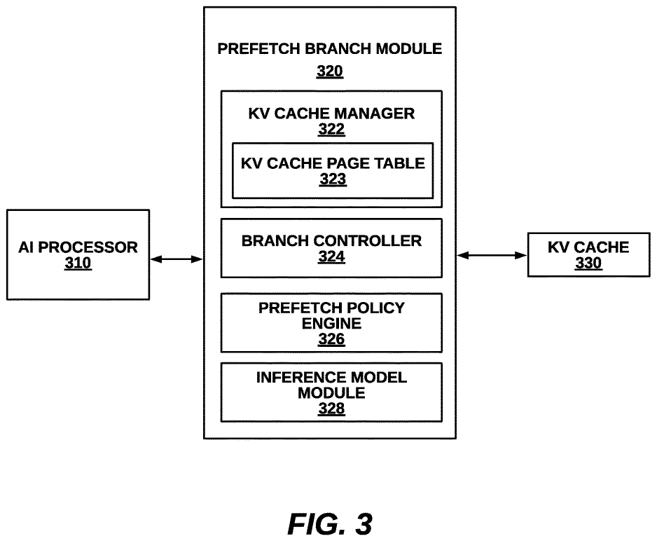

In FIG. 3 a prefetch branch module 320 is shown in context between an AI processor 310 and a KV cache 330. The prefetch branch module 320 can be located in one or more of HBM, RAM, on-chip memory and includes a KV cache manager 322, branch controller 324, prefetch policy engine 326, and inference model module 328.

The AI processor 310 may comprise one or more central processing units, graphics processing units, tensor processing units, neural processing units, application-specific integrated circuits, field-programmable gate arrays, inference accelerators, or combinations thereof. The hardware memory 120 may comprise high-bandwidth memory, accelerator memory, stacked memory, on-chip static random-access memory, graphics memory, system memory, or a distributed memory hierarchy.

The KV cache page table 210 can be maintained by the KV cache manager 322. In one embodiment, the virtualized KV cache stores key tensors, value tensors, attention-state data, compressed attention state, branch-specific continuation state, or other reusable inference state generated during execution of the inference model. The KV cache page table 210 stores mappings between branch identifiers, prompt identifiers, voice-response option identifiers, memory pointers, page descriptors, cache-block identifiers, base-state identifiers, branch-specific state identifiers, or other addressing metadata. The KV cache page table 210 enables the system to locate a base KV cache state and one or more branch-specific KV cache states without recomputing model state from the original input sequence. In some embodiments, the virtualized KV cache is organized as blocks, pages, page chains, cache segments, memory regions, or other addressable memory units.

The branch controller 324 generates and manages alternative continuation branches. A continuation branch represents a possible extension of a model response beyond a primary response. Each continuation branch may include a divergent token sequence, a natural-language prompt label, a voice-response option, a tool-use continuation, an agentic plan, a code-edit option, a retrieval path, or another selectable continuation path.

The inference model module 328 can inference remotely at data center and/or edge inference locally.

The display interface may display a primary response together with multiple selectable user prompts corresponding to alternative continuation branches. The audio interface 140 may output a spoken primary response together with audible response options, or may receive a spoken selection signal identifying one of the response options. In some embodiments, both the display interface 130 and the audio interface are present, thereby supporting multimodal branch selection.

### A. Cache-Backed Selectable Continuation Branches

In one embodiment, the inference system 100 receives an initial query from a user, application, agent, or process. The initial query may include text, speech, images, code, structured data, tool output data, sensor data, or multimodal input. The AI processor 310 executes a forward pass of the inference model 180 to generate a primary response.

During execution of the forward pass, the inference model 180 computes a base KV cache state corresponding to at least a portion of the initial query, conversation history, retrieved context, system prompt, and generated primary response. The base KV cache state may be stored in a first allocated block of the hardware memory. The KV cache page table 210 may store a base-state pointer identifying the memory location of the base KV cache state.

After or during generation of the primary response, the branch controller 324 generates a plurality of alternative continuation branches extending from the primary response. Each alternative continuation branch corresponds to a divergent token sequence. A divergent token sequence may include one or more tokens that differ from tokens associated with other continuation branches after a branch point.

The AI processor 310 computes a branch-specific KV cache state for each of the alternative continuation branches. In some embodiments, each branch-specific KV cache state includes KV cache entries generated for the divergent token sequence of a corresponding branch. In other embodiments, a branch-specific KV cache state includes a branch delta, suffix state, page chain, compressed continuation state, or other representation associated with continuation from the base KV cache state.

The KV cache manager 322 retains the base KV cache state and each branch-specific KV cache state in the hardware memory 120. In one embodiment, the KV cache manager 150 registers a distinct memory pointer for each respective branch-specific KV cache state within the KV cache page table 210. A branch identifier or prompt identifier may be stored in association with each distinct memory pointer.

The display interface displays or otherwise outputs the primary response simultaneously with multiple selectable user prompts. Each selectable user prompt is generated based on a corresponding one of the alternative continuation branches. For example, a primary response may be accompanied by prompts such as “explain in more detail,” “show an example,” “draft a claim,” “compare alternatives,” or “continue with the strongest option.” These labels are illustrative only.

Unlike conventional suggested prompts that merely provide text labels, a selectable user prompt in some embodiments is backed by a retained branch-specific KV cache state. In this manner, the displayed prompt corresponds to an already-computed continuation branch or to a continuation branch for which at least a portion of branch-specific inference state has been computed and retained. In one embodiment, suggestions can be dynamically updated, based on further processing, as more time goes by without a selection.

Upon receiving a selection signal identifying a target prompt from the selectable user prompts, the branch controller 160 resolves the target prompt to a corresponding branch identifier or memory pointer. The KV cache manager 150 resolves the distinct memory pointer within the KV cache page table 210 corresponding to the branch-specific KV cache state of the target prompt.

The AI processor 310 fetches the branch-specific KV cache state associated with the resolved memory pointer into one or more computational cores. Generation of a subsequent response is then resumed from the target prompt or selected continuation branch. By using the fetched branch-specific KV cache state, the system avoids recomputation of attention-state computations for the initial query and the divergent token sequence associated with the target prompt.

In some embodiments, non-selected branch-specific KV cache states may be retained temporarily for backtracking, multi-branch exploration, or later selection. In other embodiments, non-selected branch-specific KV cache states may be invalidated, evicted, compressed, demoted to a lower memory tier, or overwritten in response to memory pressure, expiration of a selection interval, or selection of a different branch.

### B. KV Cache Page Table

FIG. 2 illustrates an example KV cache page table 210. The page table 210 may include entries for a base cache state and multiple branch-specific cache states. Each entry may include a branch identifier, prompt identifier, voice-response identifier, memory pointer, memory-block identifier, page-chain descriptor, token-range descriptor, validity bit, retention priority, predicted selection probability, prefetch value, compression status, memory-tier identifier, or expiration timestamp.

In one embodiment, a base cache entry identifies a first allocated memory block storing a base KV cache state. Branch entries identify second, third, or additional allocated memory blocks storing branch-specific KV cache states. A branch entry may reference the base cache entry, thereby indicating that the branch-specific state should be used together with the base state to resume generation from a selected branch.

In some embodiments, the page table 210 supports copy-on-write, reference counting, shared-prefix references, suffix-only branch state, compressed branch pages, partial branch-page loading, or selective invalidation of branch-specific state. A branch-specific KV cache state may therefore share common inherited state with other branches while retaining only the divergent token state needed for the corresponding branch.

The KV cache page table 210 may be implemented in hardware, firmware, driver software, inference-runtime software, accelerator memory-management logic, serving-layer middleware, or combinations thereof. In some embodiments, the page table 210 is maintained by a memory controller or inference-serving runtime configured to virtualize KV cache memory across multiple user sessions, requests, or continuation branches.

### C. Voice-Driven Continuation Branching

A voice-driven continuation branching system. The system can include audio interface, a speech recognition module, a speech synthesis module, and a voice-to-branch identifier table. The audio interface may include a microphone, speaker, headset, vehicle audio system, mobile device audio interface, smart-speaker interface, or other audio input/output component.

In one embodiment, the system receives an initial spoken query through the audio interface. The AI processor 310 executes a forward pass of the inference model to generate a primary response, and the speech synthesis module outputs the primary response as a primary voice response.

The branch controller generates multiple alternative continuation branches extending from the primary voice response. Each branch corresponds to a divergent token sequence and may be associated with an audible selectable response option. The audible selectable response options may include spoken prompts, short verbal menus, semantically distinct voice choices, or natural-language continuation alternatives.

The system maintains the voice-to-branch identifier table. The voice-to-branch identifier table maps each voice-response option to a branch identifier associated with a corresponding branch-specific KV cache state retained in the hardware memory. In some embodiments, the table maps recognized speech intents, semantic embeddings of spoken selections, menu numbers, phonetic patterns, or natural-language variants to corresponding branch identifiers.

The audio interface outputs the primary response together with one or more audible prompts identifying the voice-response options. For example, the system may output: “I can explain the legal strategy, draft claims, or compare prior art. Which would you like?” Each audible option may correspond to a branch-specific KV cache state already computed or selected for computation.

The audio interface receives a spoken selection signal identifying a target voice-response option. The speech recognition module converts the spoken selection signal into recognized text, semantic intent, branch-selection intent, or another selection representation. The branch controller resolves a target branch identifier using the voice-to-branch identifier table.

The KV cache manager resolves a distinct memory pointer within the KV cache page table 210 corresponding to the branch-specific KV cache state of the target voice-response option. The AI processor 310 fetches the corresponding branch-specific KV cache state and resumes generation of a subsequent voice response, thereby avoiding recomputation of attention-state computations for the initial spoken query and the divergent token sequence associated with the target voice-response option.

In some embodiments, the voice-to-branch identifier table is updated dynamically based on conversational context, recognized user preferences, semantic similarity between spoken input and response options, confidence scores of speech recognition, or predicted branch-selection likelihood.

### D. Resource-Aware Prefetch Policy for Branch-Specific Continuation States

In some embodiments, generation of alternative continuation branches and corresponding branch-specific KV cache states is controlled by a resource-aware prefetch policy. The prefetch policy determines whether, when, and to what extent one or more continuation branches should be precomputed before a user selects a corresponding selectable prompt or voice-response option. In this manner, the inference system may exploit periods of relatively low processing cost or available accelerator capacity to prepare branch-specific KV cache states in advance, while reducing or suppressing speculative branch computation during periods of high system load.

The prefetch policy may evaluate one or more runtime resource conditions, including accelerator utilization, GPU utilization, NPU utilization, tensor-core utilization, request queue depth, batch occupancy, high-bandwidth memory availability, KV-cache memory pressure, memory bandwidth utilization, interconnect utilization, power budget, thermal headroom, latency target, service-level objective, user subscription tier, model priority, or estimated marginal cost of branch precomputation.

In one embodiment, branch precomputation is enabled when one or more resource conditions satisfy a prefetch threshold, such as when accelerator utilization is below a utilization threshold, request queue depth is below a queue-depth threshold, or available KV-cache memory exceeds a memory-availability threshold. Conversely, branch precomputation may be reduced, delayed, truncated, compressed, demoted, or disabled when the runtime resource conditions indicate that the inference system is busy, congested, thermally constrained, memory constrained, or required to prioritize primary user requests.

In one implementation, the prefetch policy generates a prefetch budget indicating a number of alternative continuation branches to compute, a maximum divergent-token length for each branch, a maximum amount of KV-cache memory to allocate to branch-specific states, or a maximum compute interval available for speculative continuation generation. For example, when the inference system is lightly loaded, the prefetch budget may authorize computation of several continuation branches having relatively longer divergent token sequences. When the inference system is moderately loaded, the prefetch budget may authorize only a reduced number of continuation branches or shorter divergent token sequences. When the inference system is heavily loaded, the prefetch budget may authorize no branch precomputation, causing the selectable prompts to be generated as text labels without retaining full branch-specific KV cache states, or causing branch-specific KV cache states to be computed only after user selection.

In some embodiments, the prefetch policy operates opportunistically during idle or underutilized processing intervals. For instance, after a primary response is generated and before a user selection is received, the AI processor 310 may identify an idle interval in which a computational core, tensor core, accelerator stream, or memory channel is available. During the idle interval, the AI processor 310 may compute one or more branch-specific KV cache states and register memory pointers for the computed states in the KV cache page table 210. Thus, otherwise unused compute capacity may be converted into lower response latency for a later user-selected continuation branch.

In some embodiments, the inference system 100 determines a prefetch value for each candidate continuation branch before allocating compute or memory resources to the branch. The prefetch value may represent an expected utility of precomputing the branch-specific KV cache state relative to the cost of computing and retaining the branch.

The prefetch value may be determined based on one or more of a predicted probability that the user will select the branch, an estimated latency reduction if the branch is selected, an estimated compute cost of precomputing the branch, an estimated memory cost of retaining the branch-specific KV cache state, an estimated expiration time for the branch, a predicted user dwell time, a predicted continuation depth, a task importance score, a user-specific preference model, or a service-level priority.

In one embodiment, the prefetch value is computed as a function of expected latency savings multiplied by a predicted selection probability, offset by one or more cost terms associated with compute usage, KV-cache memory usage, power usage, or opportunity cost. For example, a continuation branch having a high predicted selection probability and a large expected recomputation cost may be assigned a high prefetch value and may be precomputed even when the system is moderately loaded. Conversely, a continuation branch having a low predicted selection probability, a short divergent token sequence, or a small expected latency benefit may be assigned a low prefetch value and may be omitted or deferred.

The prefetch policy may compare the prefetch value of each candidate continuation branch against a prefetch-value threshold. Branches satisfying the prefetch-value threshold may be precomputed and retained in the virtualized KV cache. Branches failing to satisfy the threshold may be represented by selectable prompt text or audible response-option text without precomputing a corresponding branch-specific KV cache state, or may be computed only after selection. In some embodiments, the threshold is dynamically adjusted based on system load, memory pressure, user priority, latency objectives, or observed selection behavior.

### E. Selection Prediction-Based Branch Prefetching

In some embodiments, the AI processor 310 predicts a likelihood that a user will select each selectable prompt or voice-response option. The prediction may be generated using one or more selection-prediction models that evaluate the initial query, the primary response, semantic content of the alternative continuation branch, historical user selections, conversation history, current application context, cursor position, gaze data, dwell time, microphone input, device state, enterprise workflow context, or aggregate selection statistics across users. The predicted selection likelihood may be stored in association with a branch identifier, a prompt identifier, or a voice-response option identifier.

The inference system 100 may rank the alternative continuation branches according to predicted selection likelihood, prefetch value, or a combined selection-and-resource score. A highest-ranked subset of branches may be precomputed and retained in hardware memory, while lower-ranked branches may be omitted, compressed, demoted to a lower memory tier, or left as non-prefetched prompt options. In one embodiment, the system presents a plurality of selectable prompts to the user but precomputes branch-specific KV cache states only for a selected subset of those prompts that are predicted to be most likely to be selected.

In another embodiment, the inference system 100 updates the selection prediction after the selectable prompts or audible response options have been presented. For example, if the user pauses over a prompt, hovers over a prompt, begins speaking words semantically associated with a voice-response option, or exhibits gaze or cursor behavior indicating likely selection of a particular branch, the system may elevate the predicted selection likelihood of that branch and initiate late prefetching of the corresponding branch-specific KV cache state. In this manner, branch precomputation may occur progressively and adaptively during the interval between presentation of selectable options and receipt of a final selection signal.

In some embodiments, a branch-specific KV cache state that has been prefetched based on predicted selection may be invalidated, compressed, evicted, or demoted if the user selects a different branch, if a selection timeout expires, if memory pressure increases, or if the prefetch value falls below a retention threshold. The KV cache page table 210 may be updated to remove or modify memory pointers associated with such non-selected or low-value branches. In some embodiments, unselected branch-specific KV cache states may be retained temporarily for subsequent user navigation, backtracking, or multi-branch exploration.

### F. Computing Device

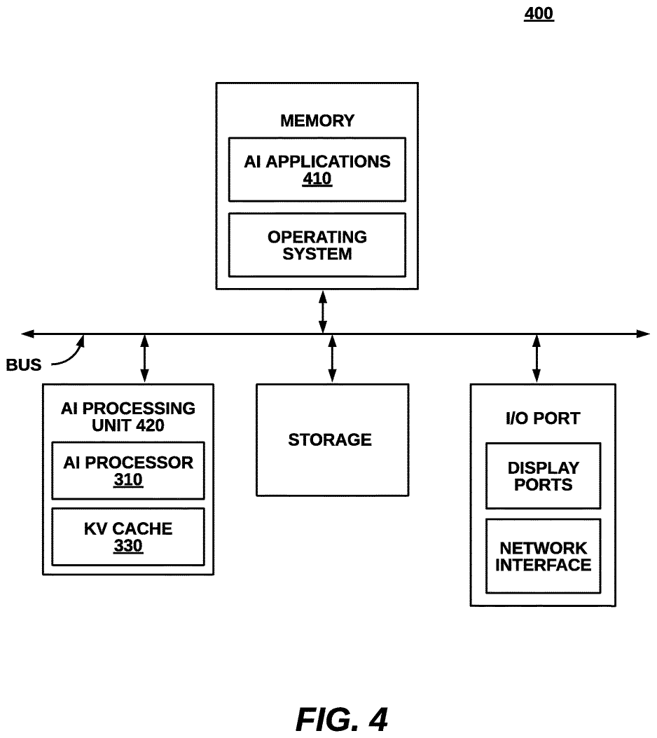

FIG. 4 illustrates a computing device 400 suitable for implementing embodiments of the present disclosure. The computing device 400 includes a memory, an AI processing unit 420, storage, and an I/O port, communicatively couple over a bus 660. The AI processing unit 420 includes one or more of AI processor 310 which can be one or more of a CPU, GPU, TPU, NPU, ASIC, FPGA, or other processing device, and KV cache 330.

The memory may store instructions that, when executed by the AI processor 310, cause the computing device 400 to perform any of the methods described herein. The memory may also store AI applications 410 (e.g., chatbot apps or Internet browsers), an inference model, a virtualized KV cache, a KV cache page table, branch identifiers, prompt identifiers, a voice-to-branch identifier table, prefetch-value data, runtime resource data, and selection-prediction data.

The computing device 400 may be implemented as a cloud inference server, data-center accelerator, local device, smartphone, personal computer, robot, vehicle computer, augmented reality device, wearable device, enterprise server, or distributed computing system. In some embodiments, components of the system are distributed across multiple machines, including a client device that presents selectable prompts and a remote inference server that maintains branch-specific KV cache states.

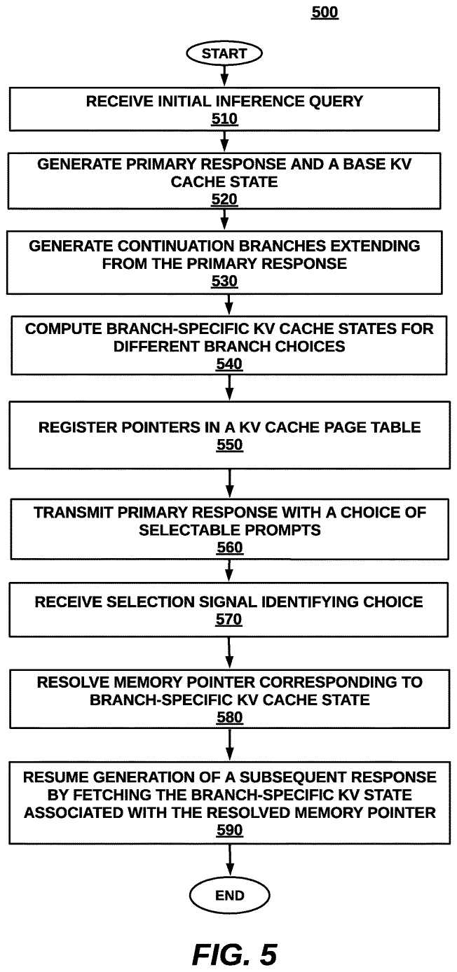

### II. Methods for KV Cache Continuation Branches (FIGS. 5-7)

The following methods describe example operations for KV cache-backed selectable continuation branching, including presenting selectable prompts or audible response options, resolving a selected continuation to a branch-specific KV cache state, and resuming generation using the selected branch-specific KV cache state.

### A. Method for Selectable Branch Continuation

FIG. 5 illustrates a method 500 for cache-backed selectable continuation branching.

At step 510, the inference system receives an initial query.

At step 520, the system executes a forward pass of an attention-based neural network model to generate a primary response and compute a base KV cache state.

At step 530, the system generates a plurality of alternative continuation branches extending from the primary response.

At step 540, the system computes branch-specific KV cache states for the alternative continuation branches.

At step 550, the system retains the base KV cache state and branch-specific KV cache states in hardware memory by registering distinct memory pointers in a KV cache page table.

At step 560, the system transmits the primary response together with a plurality of selectable prompts.

At step 570, the system receives a selection signal identifying a target prompt.

At step 580, the system resolves the memory pointer corresponding to the branch-specific KV cache state of the selected prompt.

At step 590, the system resumes generation of a subsequent response by fetching the branch-specific KV cache state associated with the resolved memory pointer, thereby avoiding recomputation of attention-state computations for the initial query and the selected divergent token sequence.

### B. Method for Resource-Aware Prefetching

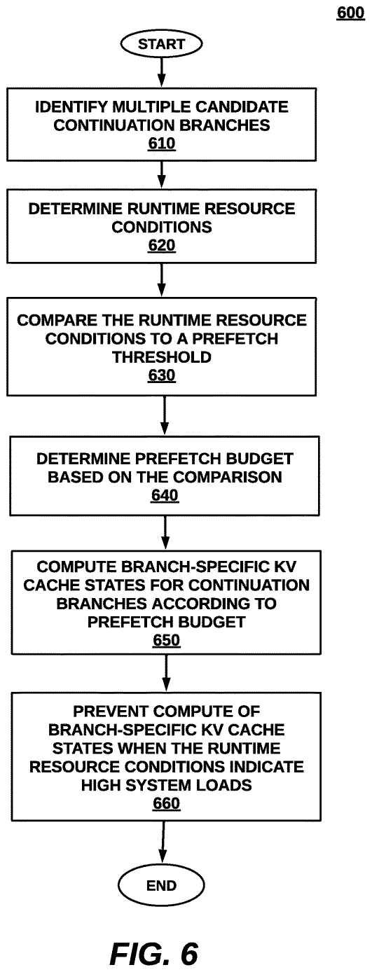

FIG. 6 illustrates a method 600 for resource-aware prefetching of branch-specific continuation states.

At step 610, the inference system generates or identifies multiple candidate continuation branches.

At step 620, the system determines runtime resource conditions, including one or more of accelerator utilization, queue depth, KV-cache memory pressure, high-bandwidth memory availability, power budget, thermal headroom, or latency target.

At step 630, the system compares the runtime resource conditions to one or more prefetch thresholds.

At step 640, the system determines a prefetch budget based on the comparison.

At step 650, the system computes branch-specific KV cache states for one or more continuation branches according to the prefetch budget.

At step 660, the system suppresses, reduces, delays, truncates, compresses, demotes, or disables computation of branch-specific KV cache states when the runtime resource conditions indicate that the inference system is busy or resource constrained.

### C. Method for Prefetch Value and Predicted Selection

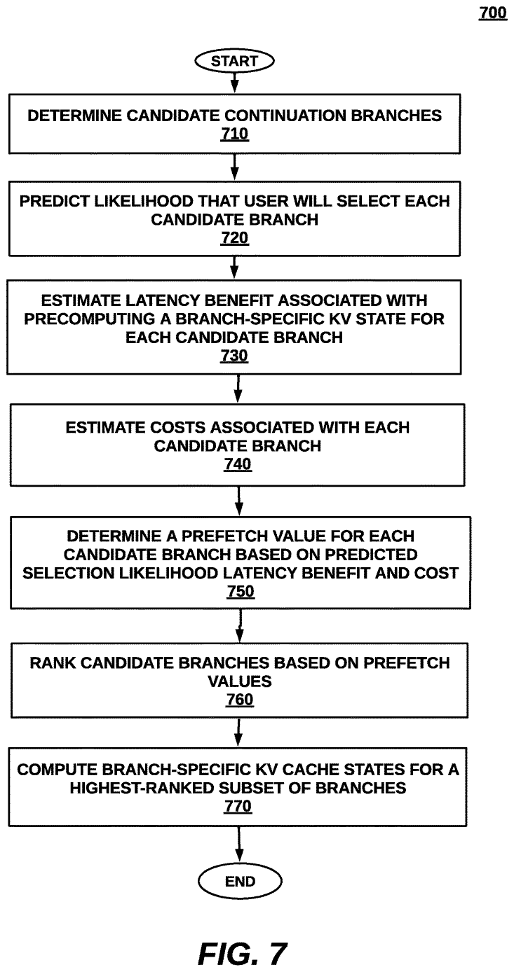

FIG. 7 illustrates a method 700 for determining prefetch value and predicted user-selection likelihood.

At step 710, the inference system determines candidate continuation branches corresponding to selectable prompts or voice-response options.

At step 720, the system predicts a likelihood that the user will select each candidate continuation branch.

At step 730, the system estimates a latency benefit associated with precomputing a branch-specific KV cache state for each candidate branch.

At step 740, the system estimates one or more costs associated with each candidate branch, including compute cost, memory cost, power cost, or opportunity cost.

At step 750, the system determines a prefetch value for each candidate branch based on the predicted selection likelihood, latency benefit, and one or more costs.

At step 760, the system ranks the candidate branches based on the prefetch values.

At step 770, the system precomputes branch-specific KV cache states for a highest-ranked subset of branches.

Optionally, the system updates prefetching based on detected user behavior indicating an increased or decreased likelihood of branch selection.

### III. Generalities

Various modifications may be made without departing from the scope of the disclosure. By way of example, the disclosed techniques may be implemented with different attention-based model architectures, different KV cache formats, different memory hierarchies, different page-table structures, different branch-generation techniques, different prompt-selection interfaces, different voice-selection interfaces, and different prefetch policies. The disclosed embodiments are not limited to any particular model provider, inference framework, accelerator type, operating system, serving platform, or user-interface format.

In some embodiments, the virtualized KV cache may be implemented using contiguous memory regions, non-contiguous cache blocks, page chains, cache segments, memory pools, shared-prefix pages, branch-specific suffix pages, compressed cache pages, or other addressable cache structures. The KV cache page table may store any suitable addressing metadata, including memory pointers, page descriptors, block identifiers, branch identifiers, prompt identifiers, voice-response option identifiers, validity indicators, reference counts, token ranges, retention priorities, prefetch values, selection-likelihood scores, memory-tier identifiers, compression indicators, or expiration timestamps.

In some embodiments, a continuation branch may correspond to a natural-language continuation, a tool-use trajectory, an agentic reasoning path, a retrieval path, a coding-assistant action, a customer-support workflow, a navigation option, a voice-response option, an enterprise workflow branch, or another selectable or process-selectable continuation path. The term “selection” may include a user selection, a spoken selection, a touch input, a pointer input, a gesture input, a gaze-based input, an application-generated selection, an agent-generated selection, a policy-generated selection, or a process-generated selection.

In some embodiments, selectable prompts or voice-response options may be generated before, during, or after computation of corresponding branch-specific KV cache states. In some cases, every displayed or audible option may be backed by a precomputed branch-specific KV cache state. In other cases, only a subset of selectable options may be backed by precomputed branch-specific KV cache states, while one or more remaining options are represented initially by labels, identifiers, embeddings, or branch descriptors and are computed after selection or during late prefetching.

In some embodiments, a branch-specific KV cache state may include a complete branch cache, a suffix cache, a delta relative to a base KV cache state, a cache page chain, a compressed continuation state, a reconstructed attention state, a partial cache state, or another reusable inference-state representation. A base KV cache state may be stored once and referenced by multiple branches, while branch-specific states may be retained as branch-local pages, suffix pages, overlays, deltas, appended cache regions, or other state objects. Copy-on-write, reference counting, validity tracking, cache-page sharing, and selective invalidation may be used to preserve branch identity while reducing memory duplication.

In some embodiments, the prefetch policy may use any suitable rule-based, learned, heuristic, optimization-based, cost-based, priority-based, or hybrid decision process. A prefetch value may be computed explicitly using a formula, inferred by a model, looked up from a policy table, assigned by a scheduler, determined by a serving controller, or derived from one or more runtime signals. A prefetch value may represent expected latency benefit, expected user value, expected system benefit, expected continuation utility, expected reduction in recomputation, or another measure of value associated with precomputing and retaining a branch-specific KV cache state.

In some embodiments, resource-aware prefetching may depend on accelerator utilization, queue depth, batch occupancy, memory availability, KV-cache memory pressure, memory bandwidth, power budget, thermal headroom, interconnect utilization, latency targets, service-level objectives, user tier, application priority, model priority, or combinations thereof. When resources are available, the system may precompute additional branches, longer divergent token sequences, or higher-quality branch states. When resources are constrained, the system may reduce a number of prefetched branches, shorten divergent token sequences, delay branch computation, demote branch states to a lower memory tier, compress branch states, or omit prefetching.

In some embodiments, predicted selection likelihood may be determined using conversation history, user profile information, prior user selections, prompt semantics, branch semantics, application context, enterprise workflow context, cursor position, dwell time, gaze direction, partial spoken input, touch behavior, gesture behavior, device state, aggregate selection statistics, or another interaction signal. Selection prediction may occur before presenting selectable options, after presenting selectable options, during a user-selection interval, or after detecting partial user behavior indicating likely selection of a particular option.

In some embodiments, branch-specific KV cache states may be retained, invalidated, evicted, compressed, encrypted, demoted, promoted, refreshed, recomputed, or otherwise managed based on memory pressure, expiration of a selection interval, selection of another branch, updated prefetch value, predicted user behavior, session policy, security policy, privacy policy, or runtime resource condition. Unselected branch-specific KV cache states may be discarded immediately, retained temporarily for backtracking or multi-branch exploration, moved to a lower memory tier, or preserved for a later user or process selection.

In some embodiments, the disclosed system may be implemented locally, remotely, or in distributed form. For example, a client device may present selectable prompts or audible response options while a remote inference server maintains the virtualized KV cache and KV cache page table. In another embodiment, an edge device, smartphone, personal computer, vehicle computer, robot, headset, wearable device, or enterprise appliance may locally maintain one or more branch-specific KV cache states. In still another embodiment, branch-specific KV cache states may be split, replicated, transferred, compressed, or reconstructed across edge devices, cloud servers, accelerator clusters, or memory tiers.

In some embodiments, the disclosed techniques may operate with text models, speech models, multimodal models, code models, reasoning models, agentic models, tool-using models, retrieval-augmented models, or hybrid inference systems. The techniques may be used in consumer assistants, enterprise copilots, coding assistants, customer-support systems, navigation assistants, automotive assistants, augmented-reality devices, robotics systems, medical or wellness assistants, financial assistants, legal assistants, education systems, and other interactive or automated artificial intelligence systems.

In some embodiments, one or more operations described as being performed by processing circuitry may be performed by a processor, accelerator, memory controller, inference server, scheduler, runtime system, operating system component, firmware component, driver component, client device, cloud service, or distributed combination thereof. Functions described as separate modules may be combined, and functions described as a single module may be distributed among multiple components.

In some embodiments, a non-transitory computer-readable medium stores instructions that, when executed by one or more processors or processing circuits, cause performance of any of the operations described herein. The instructions may be embodied in firmware, runtime software, inference-serving software, model-serving middleware, operating-system software, application software, device software, cloud software, or combinations thereof.

The foregoing description of embodiments of the present disclosure has been presented for purposes of illustration and description and is not intended to be exhaustive or to limit the disclosure to the precise forms disclosed. Many modifications, substitutions, and variations will be apparent to those of ordinary skill in the art in light of the above teachings.

Therefore, the scope of the invention is defined by the appended claims and their equivalents, rather than by the specific embodiments described herein.

I claim:

1. An artificial intelligence inference system for optimizing memory allocation, the system comprising:
a display interface;
a hardware memory configured to maintain a virtualized key-value (KV) cache; and
processing circuitry communicatively coupled to the hardware memory and the display interface, the processing circuitry configured to:
receive an initial query;
execute a forward pass of an attention-based neural network model to generate a primary response, wherein executing the forward pass computes a base KV cache state stored within a first allocated block of the hardware memory;
generate a plurality of alternative continuation branches extending from the primary response, wherein each alternative continuation branch corresponds to a divergent token sequence;
compute a branch-specific KV cache state for each of the plurality of alternative continuation branches;
retain the base KV cache state and each branch-specific KV cache state in the hardware memory by registering a distinct memory pointer for each respective branch-specific KV cache state within a KV cache page table;
transmit, to the display interface, the primary response simultaneously with a plurality of selectable user prompts, wherein each selectable user prompt is generated based on a corresponding one of the plurality of alternative continuation branches;
receive a selection signal identifying a target prompt from the plurality of selectable user prompts;
resolve, in response to the selection signal, the distinct memory pointer within the KV cache page table corresponding to the branch-specific KV cache state of the target prompt; and
resume generation of a subsequent response extending from the target prompt by fetching the branch-specific KV cache state associated with the resolved distinct memory pointer into a computational core of the processing circuitry, without recomputation of attention matrices for the initial query and the divergent token sequence associated with the target prompt.

2. An artificial intelligence inference system for optimizing memory allocation during voice-driven continuation branching, the system comprising:
an audio interface;
a hardware memory configured to maintain a virtualized key-value (KV) cache; and
processing circuitry communicatively coupled to the hardware memory and the audio interface, the processing circuitry configured to:
receive an initial query;
execute a forward pass of an attention-based neural network model to generate a primary response, wherein executing the forward pass computes a base KV cache state stored within a first allocated block of the hardware memory;
generate a plurality of alternative continuation branches extending from the primary response, wherein each alternative continuation branch corresponds to a divergent token sequence;
compute, for each alternative continuation branch, a branch-specific KV cache state representing KV-cache entries generated for the divergent token sequence of the respective alternative continuation branch;
retain the base KV cache state and each branch-specific KV cache state in the hardware memory by registering a distinct memory pointer for each respective branch-specific KV cache state within a KV cache page table;
generate a plurality of voice-response options corresponding to the plurality of alternative continuation branches;
maintain a voice-to-branch identifier table that maps each voice-response option to a branch identifier associated with a corresponding branch-specific KV cache state retained in the hardware memory;
output, through the audio interface, the primary response together with at least one audible prompt identifying the plurality of voice-response options;
receive, through the audio interface, a spoken selection signal identifying a target voice-response option from the plurality of voice-response options;
resolve, using the voice-to-branch identifier table, a target branch identifier corresponding to the target voice-response option;
resolve, using the target branch identifier, a distinct memory pointer within the KV cache page table corresponding to the branch-specific KV cache state of the target voice-response option; and
resume generation of a subsequent voice response extending from the target voice-response option by fetching the branch-specific KV cache state associated with the resolved distinct memory pointer into a computational core of the processing circuitry, without recomputation of attention matrices for the initial query and the divergent token sequence associated with the target voice-response option.

3. The artificial intelligence inference system of claim 1, wherein the processing circuitry is further configured to determine a runtime resource condition of the artificial intelligence inference system, compare the runtime resource condition to a branch-prefetch threshold, and compute at least one of the branch-specific KV cache states only responsive to the runtime resource condition satisfying the branch-prefetch threshold.

4. The artificial intelligence inference system of claim 3, wherein the runtime resource condition comprises one or more of accelerator utilization, request queue depth, high-bandwidth memory availability, KV-cache memory pressure, memory bandwidth utilization, power budget, thermal headroom, latency target, or estimated marginal cost of branch precomputation.

5. The artificial intelligence inference system of claim 1, wherein the processing circuitry is further configured to determine a prefetch value for each of the plurality of alternative continuation branches and to compute branch-specific KV cache states for only a subset of the plurality of alternative continuation branches based on the prefetch values.

6. The artificial intelligence inference system of claim 5, wherein the prefetch value is based on at least a predicted probability that a user will select a corresponding selectable user prompt and an estimated latency reduction resulting from precomputing the corresponding branch-specific KV cache state.

7. The artificial intelligence inference system of claim 5, wherein the prefetch value is further based on one or more of an estimated compute cost, an estimated KV-cache memory cost, an estimated expiration time, a user priority, or a service-level objective.

8. The artificial intelligence inference system of claim 1, wherein the processing circuitry is further configured to rank the plurality of alternative continuation branches based on predicted user-selection likelihood and to precompute branch-specific KV cache states for a highest-ranked subset of the plurality of alternative continuation branches.

9. The artificial intelligence inference system of claim 1, wherein the processing circuitry is further configured to initiate late prefetching of a branch-specific KV cache state responsive to detecting user behavior indicating an increased likelihood of selection of a corresponding selectable user prompt.

10. The artificial intelligence inference system of claim 9, wherein the user behavior comprises one or more of cursor hover, dwell time, gaze direction, partial spoken input, semantic similarity between spoken input and a selectable user prompt, or interaction history.

11. The artificial intelligence inference system of claim 1, wherein the processing circuitry is further configured to suppress or reduce computation of the branch-specific KV cache states responsive to determining that accelerator utilization, request queue depth, or KV-cache memory pressure exceeds a corresponding busy-system threshold.

12. The artificial intelligence inference system of claim 1, wherein the processing circuitry is further configured to evict, compress, invalidate, or demote at least one non-selected branch-specific KV cache state responsive to memory pressure, expiration of a selection interval, or selection of a different continuation branch.

13. The artificial intelligence inference system of claim 1, wherein each selectable user prompt comprises a natural-language label derived from a corresponding precomputed divergent token sequence.

14. The artificial intelligence inference system of claim 1, wherein the KV cache page table stores a branch identifier, a prompt identifier, a memory pointer, and a validity indicator for each of the plurality of alternative continuation branches.

15. The artificial intelligence inference system of claim 1, wherein at least one branch-specific KV cache state comprises a branch delta relative to the base KV cache state.

16. The artificial intelligence inference system of claim 1, wherein the processing circuitry is further configured to retain the base KV cache state as shared-prefix state and to retain each branch-specific KV cache state as suffix state associated with a corresponding divergent token sequence.

17. The artificial intelligence inference system of claim 2, wherein the voice-to-branch identifier table maps a plurality of speech-recognition alternatives to a common branch identifier.

18. The artificial intelligence inference system of claim 2, wherein the processing circuitry is further configured to initiate late prefetching of a branch-specific KV cache state responsive to partial spoken input having semantic similarity to one of the plurality of voice-response options.

19. A computer-implemented method for optimizing memory allocation during artificial intelligence inference, the method comprising:
receiving an initial query;
executing a forward pass of an attention-based neural network model to generate a primary response and a base KV cache state;
generating a plurality of alternative continuation branches extending from the primary response;
computing branch-specific KV cache states for the plurality of alternative continuation branches;
registering distinct memory pointers for the branch-specific KV cache states in a KV cache page table;
presenting selectable user prompts corresponding to the plurality of alternative continuation branches;
receiving a selection signal identifying a target prompt;
resolving a memory pointer in the KV cache page table corresponding to the target prompt; and
resuming generation of a subsequent response using the branch-specific KV cache state associated with the resolved memory pointer.

20. A non-transitory computer-readable medium storing instructions that, when executed by processing circuitry, cause the processing circuitry to perform operations comprising:
receiving an initial query;
executing an attention-based neural network model to generate a primary response and a base KV cache state;
generating a plurality of alternative continuation branches extending from the primary response;
computing branch-specific KV cache states for the plurality of alternative continuation branches;
registering distinct memory pointers for the branch-specific KV cache states in a KV cache page table;
presenting selectable continuation options corresponding to the plurality of alternative continuation branches;
receiving a selection signal identifying a selected continuation option;
resolving a memory pointer corresponding to the selected continuation option; and
resuming generation using the branch-specific KV cache state associated with the resolved memory pointer.
